(19) United States
(12) Patent Application Publication
(10) Pub. No.: US 2025/0240437 A1
(43) Pub. Date: Jul. 24, 2025

(54) METHOD AND APPARATUS FOR ENCODING/DECODING IMAGE AND RECORDING MEDIUM FOR STORING BITSTREAM

(71) Applicants: HYUNDAI MOTOR COMPANY, Seoul (KR); KIA CORPORATION, Seoul (KR)

(72) Inventors: Jin Heo, Yongin-si (KR); Seung Wook Park, Yongin-si (KR)

(73) Assignees: HYUNDAI MOTOR COMPANY, Seoul (KR); KIA CORPORATION, Seoul (KR)

(21) Appl. No.: 18/855,550

(22) PCT Filed: Apr. 10, 2023
(86) PCT No.: PCT/KR2023/004823

§ 371 Date: Oct. 9, 2024

(30) Foreign Application Priority Data
Apr. 11, 2022 (KR) 10-2022-0044340
Apr. 10, 2023 (KR) 10-2023-0046864

(51) Int. Cl. H04N 19/186; G06V 10/50; H04N 19/159; H04N 19/176; H04N 19/91

(52) U.S. Cl. CPC H04N 19/186; G06V 10/50; H04N 19/159; H04N 19/176; H04N 19/91

(57) ABSTRACT

An image encoding/decoding method and apparatus, a recording medium for storing a bitstream and a transmission method are provided. The image decoding method comprises generating a chroma mode list of a current chroma block, deriving a chroma intra prediction mode of the current chroma block based on the chroma mode list, and generating a prediction block of the current chroma block based on the chroma intra prediction mode. The chroma mode list may comprise at least one of a default mode, a derivation based chroma mode or a direct mode.

### CROSS-REFERENCE TO RELATED APPLICATION

This application is a U.S. national stage of International Application No. PCT/KR2023/004823, filed on Apr. 10, 2023, which claims priority to Korean Patent Application No. 10-2022-0044340, filed on Apr. 11, 2022, and Korean Patent Application No. 10-2023-0046864, filed on Apr. 10, 2023, the entire contents of each of which are hereby incorporated herein by reference.

### TECHNICAL FIELD

The present invention relates to an image encoding/decoding method and apparatus and a recording medium for storing a bitstream. More particularly, the present invention relates to an image encoding/decoding method and apparatus using a derivation based chroma mode and a recording medium for storing a bitstream.

### BACKGROUND

Recently, the demand for high-resolution, high-quality images such as ultra-high definition (UHD) images is increasing in various application fields. As image data becomes higher in resolution and quality, the amount of data increases relatively compared to existing image data. Therefore, when transmitting image data using media such as existing wired and wireless broadband lines or storing image data using existing storage media, the transmission and storage costs increase. In order to solve these problems that occur as image data becomes higher in resolution and quality, high-efficiency image encoding/decoding technology for images with higher resolution and quality is required.

### SUMMARY

An object of the present invention is to provide an image encoding/decoding method and apparatus with improved encoding/decoding efficiency.

Another object of the present invention is to provide a recording medium for storing a bitstream generated by an image decoding method or apparatus according to the present invention.

A image decoding method according to an embodiment of the present invention may comprise generating a chroma mode list of a current chroma block, deriving a chroma intra prediction mode of the current chroma block based on the chroma mode list and generating a prediction block of the current chroma block based on the chroma intra prediction mode. The chroma mode list may comprise at least one of a default mode, a derivation based chroma mode or a direct mode.

In the image decoding method, the derivation based chroma mode may be derived using a reconstructed pixel of a collocated luma block at a collocated position of the current chroma block.

In the image decoding method, the reconstructed pixel of the collocated luma block may be a pixel selected by sampling.

In the image decoding method, the derivation based chroma mode may be derived using a reconstructed neighboring reference pixel of the current chroma block.

In the image decoding method, the neighboring reference pixel may be a pixel directly adjacent to the current chroma block.

In the image decoding method, the neighboring reference pixel may comprise at least one of a neighboring reference pixel adjacent to the current chroma block or a neighboring reference block adjacent to the collocated block of the current chroma block.

In the image decoding method, the chroma mode list may be configured in the order of the direct mode, the derivation based chroma mode and the default mode.

In the image decoding method, the chroma mode list may be configured in an order determined based on a histogram of gradient for deriving the derivation based chroma mode.

In the image decoding method, when the direct mode and the derivation based chroma mode are the same intra prediction mode, the chroma intra prediction mode of the current chroma block may be set to the same intra prediction mode.

In the image decoding method, when there is a default mode having the same intra prediction mode as the direct mode or the derivation based chroma mode, the default mode may be replaced with a predefined chroma intra prediction mode.

An image encoding method according to an embodiment of the present invention may comprise generating a chroma mode list of a current chroma block, deriving a chroma intra prediction mode of the current chroma block based on the chroma mode list, and generating a prediction block of the current chroma block based on the chroma intra prediction mode. The chroma mode list may comprise at least one of a default mode, a derivation based chroma mode or a direct mode.

A non-transitory computer-readable recording medium according to an embodiment of the present invention may store a bitstream generated by an image encoding method comprising generating a chroma mode list of a current chroma block, deriving a chroma intra prediction mode of the current chroma block based on the chroma mode list, and generating a prediction block of the current chroma block based on the chroma intra prediction mode. The chroma mode list may comprise at least one of a default mode, a derivation based chroma mode or a direct mode.

A method of transmitting a bitstream generated by an image encoding method according to an embodiment of the present invention may comprise transmitting the bitstream. The image encoding method may comprise generating a chroma mode list of a current chroma block, deriving a chroma intra prediction mode of the current chroma block based on the chroma mode list, and generating a prediction block of the current chroma block based on the chroma intra prediction mode. The chroma mode list may comprise at least one of a default mode, a derivation based chroma mode or a direct mode.

The features briefly summarized above with respect to the present disclosure are merely exemplary aspects of the detailed description below of the present disclosure, and do not limit the scope of the present disclosure.

According to the present invention, it is possible to provide an image encoding/decoding method and apparatus with improved encoding/decoding efficiency.

In addition, according to the present invention, a derivation based chroma mode derivation method, a chroma intra prediction mode derivation method and a method of generating a final chroma prediction block based on a weighted sum can be provided.

In addition, according to the present invention, it is possible to improve encoding efficiency in chroma intra prediction.

It will be appreciated by persons skilled in the art that that the effects that can be achieved through the present disclosure are not limited to what has been particularly described hereinabove and other advantages of the present disclosure will be more clearly understood from the detailed description.

### BRIEF DESCRIPTION OF THE DRAWINGS

FIG. 1 is a block diagram showing a configuration of an encoding apparatus an embodiment of the present invention.

FIG. 2 is a block diagram showing a configuration of a decoding apparatus according to an embodiment of the present invention.

FIG. 3 is a diagram schematically showing a video coding system to which the present invention is applicable.

FIG. 4 is a view for explaining a method of deriving a DIMD chroma mode based on a collocated luma block according to an embodiment of the present invention.

FIGS. 5 and 6 are views for explaining a method of deriving a DIMD chroma mode based on a neighboring reference pixel according to an embodiment of the present invention.

FIG. 7 is a flowchart illustrating a method of deriving a chroma intra prediction mode using a DIMD chroma mode according to an embodiment of the present invention.

FIG. 8 is a flowchart illustrating a method of deriving a chroma intra prediction mode according to an embodiment of the present invention.

FIGS. 9 to 12 are views for explaining a method of generating a chroma mode list according to an embodiment of the present invention.

FIG. 13 is a flowchart illustrating a method of deriving a chroma intra prediction mode according to an embodiment of the present invention.

FIG. 14 is a flowchart illustrating a method of generating a final chroma prediction block based on a weighted sum of a plurality of chroma prediction blocks according to an embodiment of the present invention.

FIG. 15 is a flowchart illustrating an image decoding method according to an embodiment of the present invention.

FIG. 16 exemplarily illustrates a content streaming system to which an embodiment according to the present invention is applicable.

### DETAILED DESCRIPTION

The present invention may have various modifications and embodiments, and specific embodiments are illustrated in the drawings and described in detail in the detailed description. However, this is not intended to limit the present invention to specific embodiments, but should be understood to include all modifications, equivalents, or substitutes included in the spirit and technical scope of the present invention. Similar reference numerals in the drawings indicate the same or similar functions throughout various aspects. The shapes and sizes of elements in the drawings may be provided by way of example for a clearer description. The detailed description of the exemplary embodiments described below refers to the accompanying drawings, which illustrate specific embodiments by way of example. These embodiments are described in sufficient detail to enable those skilled in the art to practice the embodiments. It should be understood that the various embodiments are different from each other, but are not necessarily mutually exclusive. For example, specific shapes, structures, and characteristics described herein may be implemented in other embodiments without departing from the spirit and scope of the present invention with respect to one embodiment. It should also be understood that the positions or arrangements of individual components within each disclosed embodiment may be changed without departing from the spirit and scope of the embodiment. Accordingly, the detailed description set forth below is not intended to be limiting, and the scope of the exemplary embodiments is defined only by the appended claims, along with the full scope of equivalents to which such claims are entitled, if properly described.

In the present invention, the terms first, second, etc. may be used to describe various components, but the components should not be limited by the terms. The terms are only used for the purpose of distinguishing one component from another. For example, without departing from the scope of the present invention, the first component may be referred to as the second component, and similarly, the second component may also be referred to as the first component. The term and/or includes a combination of a plurality of related described items or any item among a plurality of related described items.

The components shown in the embodiments of the present invention are independently depicted to indicate different characteristic functions, and do not mean that each component is formed as a separate hardware or software configuration unit. That is, each component is listed and included as a separate component for convenience of explanation, and at least two of the components may be combined to form a single component, or one component may be divided into multiple components to perform a function, and embodiments in which components are integrated and embodiments in which each component is divided are also included in the scope of the present invention as long as they do not deviate from the essence of the present invention.

The terminology used in the present invention is only used to describe specific embodiments and is not intended to limit the present invention. The singular expression includes the plural expression unless the context clearly indicates otherwise. In addition, some components of the present invention are not essential components that perform essential functions in the present invention and may be optional components only for improving performance. The present invention may be implemented by including only essential components for implementing the essence of the present invention excluding components only used for improving performance, and a structure including only essential components excluding optional components only used for improving performance is also included in the scope of the present invention.

In an embodiment, the term “at least one” may mean one of a number greater than or equal to 1, such as 1, 2, 3, and 4. In an embodiment, the term “a plurality of” may mean one of a number greater than or equal to 2, such as 2, 3, and 4.

Hereinafter, embodiments of the present invention will be specifically described with reference to the drawings. In describing the embodiments of this specification, if it is determined that a detailed description of a related known configuration or function may obscure the subject matter of this specification, the detailed description will be omitted, and the same reference numerals will be used for the same components in the drawings, and repeated descriptions of the same components will be omitted.

### Description of Terms

Hereinafter, “image” may mean one picture constituting a video, and may also refer to the video itself. For example, “encoding and/or decoding of an image” may mean “encoding and/or decoding of a video,” and may also mean “encoding and/or decoding of one of images constituting the video.”

Hereinafter, “moving image” and “video” may be used with the same meaning and may be used interchangeably. In addition, a target image may be an encoding target image that is a target of encoding and/or a decoding target image that is a target of decoding. In addition, the target image may be an input image input to an encoding apparatus and may be an input image input to a decoding apparatus. Here, the target image may have the same meaning as a current image.

Hereinafter, encoder and image encoding apparatus may be used with the same meaning and may be used interchangeably.

Hereinafter, decoder and image decoding apparatus may be used with the same meaning and may be used interchangeably.

Hereinafter, “image”, “picture”, “frame” and “screen” may be used with the same meaning and may be used interchangeably.

Hereinafter, a “target block” may be an encoding target block that is a target of encoding and/or a decoding target block that is a target of decoding. In addition, the target block may be a current block that is a target of current encoding and/or decoding. For example, “target block” and “current block” may be used with the same meaning and may be used interchangeably.

Hereinafter, “block” and “unit” may be used with the same meaning and may be used interchangeably. In addition, “unit” may mean including a luma component block and a chroma component block corresponding thereto in order to distinguish it from a block. For example, a coding tree unit (CTU) may be composed of one luma component (Y) coding tree block (CTB) and two chroma component (Cb, Cr) coding tree blocks related to it.

Hereinafter, “sample”, “picture element” and “pixel” may be used with the same meaning and may be used interchangeably. Herein, a sample may represent a basic unit that constitutes a block.

Hereinafter, “inter” and “inter-screen” may be used with the same meaning and can be used interchangeably.

Hereinafter, “intra” and “in-screen” may be used with the same meaning and can be used interchangeably.

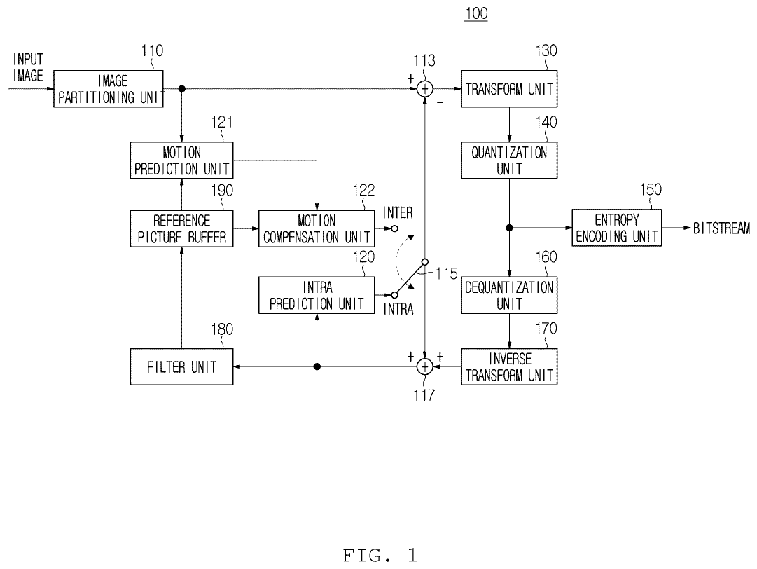

FIG. 1 is a block diagram showing a configuration of an encoding apparatus according to an embodiment of the present invention.

The encoding apparatus 100 may be an encoder, a video encoding apparatus, or an image encoding apparatus. A video may include one or more images. The encoding apparatus 100 may sequentially encode one or more images.

Referring to FIG. 1, the encoding apparatus 100 may include an image partitioning unit 110, an intra prediction unit 120, a motion prediction unit 121, a motion compensation unit 122, a switch 115, a subtractor 125, a transform unit 130, a quantization unit 140, an entropy encoding unit 150, a dequantization unit 160, an inverse transform unit 170, an adder 117, a filter unit 180 and a reference picture buffer 190.

In addition, the encoding apparatus 100 may generate a bitstream including information encoded through encoding of an input image, and output the generated bitstream. The generated bitstream may be stored in a computer-readable recording medium, or may be streamed through a wired/wireless transmission medium.

The image partitioning unit 110 may partition the input image into various forms to increase the efficiency of video encoding/decoding. That is, the input video is composed of multiple pictures, and one picture may be hierarchically partitioned and processed for compression efficiency, parallel processing, etc. For example, one picture may be partitioned into one or multiple tiles or slices, and then partitioned again into multiple CTUs (Coding Tree Units). Alternatively, one picture may first be partitioned into multiple sub-pictures defined as groups of rectangular slices, and each sub-picture may be partitioned into the tiles/slices. Here, the sub-picture may be utilized to support the function of partially independently encoding/decoding and transmitting the picture. Since multiple sub-pictures may be individually reconstructed, it has the advantage of easy editing in applications that configure multi-channel inputs into one picture. In addition, a tile may be divided horizontally to generate bricks. Here, the brick may be utilized as the basic unit of parallel processing within the picture. In addition, one CTU may be recursively partitioned into quad trees (QTs), and the terminal node of the partition may be defined as a CU (Coding Unit). The CU may be partitioned into a PU (Prediction Unit), which is a prediction unit, and a TU (Transform Unit), which is a transform unit, to perform prediction and partition. Meanwhile, the CU may be utilized as the prediction unit and/or the transform unit itself. Here, for flexible partition, each CTU may be recursively partitioned into multi-type trees (MTTs) as well as quad trees (QTs). The partition of the CTU into multi-type trees may start from the terminal node of the QT, and the MTT may be composed of a binary tree (BT) and a triple tree (TT). For example, the MTT structure may be classified into a vertical binary split mode (SPLIT_BT_VER), a horizontal binary split mode (SPLIT_BT_HOR), a vertical ternary split mode (SPLIT_TT_VER), and a horizontal ternary split mode (SPLIT_TT_HOR). In addition, a minimum block size (MinQTSize) of the quad tree of the luma block during partition may be set to 16×16, a maximum block size (MaxBtSize) of the binary tree may be set to 128×128, and a maximum block size (MaxTtSize) of the triple tree may be set to 64×64. In addition, a minimum block size (MinBtSize) of the binary tree and a minimum block size (MinTtSize) of the triple tree may be specified as 4×4, and the maximum depth (MaxMttDepth) of the multi-type tree may be specified as 4. In addition, in order to increase the encoding efficiency of the I slice, a dual tree that differently uses CTU partition structures of luma and chroma components may be applied. On the other hand, in P and B slices, the luma and chroma CTBs (Coding Tree Blocks) within the CTU may be partitioned into a single tree that shares the coding tree structure.

The encoding apparatus 100 may perform encoding on the input image in the intra mode and/or the inter mode. Alternatively, the encoding apparatus 100 may perform encoding on the input image in a third mode (e.g., IBC mode, Palette mode, etc.) other than the intra mode and the inter mode. However, if the third mode has functional characteristics similar to the intra mode or the inter mode, it may be classified as the intra mode or the inter mode for convenience of explanation. In the present invention, the third mode will be classified and described separately only when a specific description thereof is required.

When the intra mode is used as the prediction mode, the switch 115 may be switched to intra, and when the inter mode is used as the prediction mode, the switch 115 may be switched to inter. Here, the intra mode may mean an intra prediction mode, and the inter mode may mean an inter prediction mode. The encoding apparatus 100 may generate a prediction block for an input block of the input image. In addition, the encoding apparatus 100 may encode a residual block using a residual of the input block and the prediction block after the prediction block is generated. The input image may be referred to as a current image which is a current encoding target. The input block may be referred to as a current block which is a current encoding target or an encoding target block.

When a prediction mode is an intra mode, the intra prediction unit 120 may use a sample of a block that has been already encoded/decoded around a current block as a reference sample. The intra prediction unit 120 may perform spatial prediction for the current block by using the reference sample, or generate prediction samples of an input block through spatial prediction. Herein, the intra prediction may mean intra prediction.

As an intra prediction method, non-directional prediction modes such as DC mode and Planar mode and directional prediction modes (e.g., 65 directions) may be applied. Here, the intra prediction method may be expressed as an intra prediction mode or an intra prediction mode.

When a prediction mode is an inter mode, the motion prediction unit 111 may retrieve a region that best matches with an input block from a reference image in a motion prediction process, and derive a motion vector by using the retrieved region. In this case, a search region may be used as the region. The reference image may be stored in the reference picture buffer 190. Here, when encoding/decoding for the reference image is performed, it may be stored in the reference picture buffer 190.

The motion compensation unit 112 may generate a prediction block of the current block by performing motion compensation using a motion vector. Herein, inter prediction may mean inter prediction or motion compensation.

When the value of the motion vector is not an integer, the motion prediction unit 111 and the motion compensation unit 112 may generate the prediction block by applying an interpolation filter to a partial region of the reference picture. In order to perform inter prediction or motion compensation, it may be determined whether the motion prediction and motion compensation mode of the prediction unit included in the coding unit is one of a skip mode, a merge mode, an advanced motion vector prediction (AMVP) mode, and an intra block copy (IBC) mode based on the coding unit and inter prediction or motion compensation may be performed according to each mode.

In addition, based on the above inter prediction method, an AFFINE mode of sub-PU based prediction, an SbTMVP (Subblock-based Temporal Motion Vector Prediction) mode, an MMVD (Merge with MVD) mode of PU-based prediction, and a GPM (Geometric Partitioning Mode) mode may be applied. In addition, in order to improve the performance of each mode, HMVP (History based MVP), PAMVP (Pairwise Average MVP), CIIP (Combined Intra/Inter Prediction), AMVR (Adaptive Motion Vector Resolution), BDOF (Bi-Directional Optical-Flow), BCW (Bi-predictive with CU Weights), LIC (Local Illumination Compensation), TM (Template Matching), OBMC (Overlapped Block Motion Compensation), etc. may be applied.

Among these, the AFFINE mode is a technology that is used in both AMVP and MERGE modes and also has high encoding efficiency. In in the existing video coding standard, since MC (Motion Compensation) is performed by considering only the parallel movement of blocks, it has a disadvantage in that it cannot properly compensate for motions that occur in reality, such as zoom-in/out and rotation. To supplement this, a four-parameter affine motion model using two control point motion vectors (CPMVs) and a six-parameter affine motion model using three control point motion vectors may be used and applied to inter prediction. Here, CPMV is a vector representing the affine motion model of one of the upper left, upper right, and lower left of the current block. The AFFINE mode is divided into AMVP or MERGE mode for CPMV encoding. Meanwhile, considering the video coding computational complexity, affine motion compensation may be performed in 4×4 block units without performing pixel-wise affine motion compensation. That is, when viewed in 4×4 block units, it is the same as the existing motion compensation, but from the perspective of the entire PU, it may be seen as affine motion compensation.

The subtractor 113 may generate a residual block by using a difference between an input block and a prediction block. The residual block may be called a residual signal. The residual signal may mean a difference between an original signal and a prediction signal. Alternatively, the residual signal may be a signal generated by transforming or quantizing, or transforming and quantizing a difference between the original signal and the prediction signal. The residual block may be a residual signal of a block unit.

The transform unit 130 may generate a transform coefficient by performing transform on a residual block, and output the generated transform coefficient. Herein, the transform coefficient may be a coefficient value generated by performing transform on the residual block. When a transform skip mode is applied, the transform unit 130 may skip transform of the residual block.

A quantized level may be generated by applying quantization to the transform coefficient or to the residual signal. Hereinafter, the quantized level may also be called a transform coefficient in embodiments.

For example, a 4×4 luma residual block generated through intra prediction is transformed using a base vector based on DST (Discrete Sine Transform), and transform may be performed on the remaining residual block using a base vector based on DCT (Discrete Cosine Transform). In addition, a transform block is partitioned into a quad tree shape for one block using ROT (Residual Quad Tree) technology, and after performing transform and quantization on each transformed block partitioned through RQT, a coded block flag (cbf) may be transmitted to increase encoding efficiency when all coefficients become 0.

As another alternative, the Multiple Transform Selection (MTS) technique, which selectively uses multiple transform bases to perform transform, may be applied. That is, instead of partitioning a CU into TUs through ROT, a function similar to TU partition may be performed through the sub-block Transform (SBT) technique. Specifically, SBT is applied only to inter prediction blocks, and unlike RQT, the current block may be partitioned into ½ or 14 sizes in the vertical or horizontal direction and then transform may be performed on only one of the blocks. For example, if it is partitioned vertically, transform may be performed on the leftmost or rightmost block, and if it is partitioned horizontally, transform may be performed on the topmost or bottommost block.

In addition, LFNST (Low Frequency Non-Separable Transform), a secondary transform technique that additionally transforms the residual signal transformed into the frequency domain through DCT or DST, may be applied. LFNST additionally performs transform on the low-frequency region of 4×4 or 8×8 in the upper left, so that the residual coefficients may be concentrated in the upper left.

The quantization unit 140 may generate a quantized level by quantizing the transform coefficient or the residual signal according to a quantization parameter (QP), and output the generated quantized level. Herein, the quantization unit 140 may quantize the transform coefficient by using a quantization matrix.

For example, a quantizer using QP values of 0 to 51 may be used. Alternatively, if the image size is larger and high encoding efficiency is required, the QP of 0 to 63 may be used. Also, a DQ (Dependent Quantization) method using two quantizers instead of one quantizer may be applied. DQ performs quantization using two quantizers (e.g., Q0 and Q1), but even without signaling information about the use of a specific quantizer, the quantizer to be used for the next transform coefficient may be selected based on the current state through a state transition model.

The entropy encoding unit 150 may generate a bitstream by performing entropy encoding according to a probability distribution on values calculated by the quantization unit 140 or on coding parameter values calculated when performing encoding, and output the bitstream. The entropy encoding unit 150 may perform entropy encoding of information on a sample of an image and information for decoding an image. For example, the information for decoding the image may include a syntax element.

When entropy encoding is applied, symbols are represented so that a smaller number of bits are assigned to a symbol having a high occurrence probability and a larger number of bits are assigned to a symbol having a low occurrence probability, and thus, the size of bit stream for symbols to be encoded may be decreased. The entropy encoding unit 150 may use an encoding method, such as exponential Golomb, context-adaptive variable length coding (CAVLC), context-adaptive binary arithmetic coding (CABAC), etc., for entropy encoding. For example, the entropy encoding unit 150 may perform entropy encoding by using a variable length coding/code (VLC) table. In addition, the entropy encoding unit 150 may derive a binarization method of a target symbol and a probability model of a target symbol/bin, and perform arithmetic coding by using the derived binarization method, and a context model.

In relation to this, when applying CABAC, in order to reduce the size of the probability table stored in the decoding apparatus, a table probability update method may be changed to a table update method using a simple equation and applied. In addition, two different probability models may be used to obtain more accurate symbol probability values.

In order to encode a transform coefficient level (quantized level), the entropy encoding unit 150 may change a two-dimensional block form coefficient into a one-dimensional vector form through a transform coefficient scanning method.

A coding parameter may include information (flag, index, etc.) encoded in the encoding apparatus 100 and signaled to the decoding apparatus 200, such as syntax element, and information derived in the encoding or decoding process, and may mean information required when encoding or decoding an image.

Herein, signaling the flag or index may mean that a corresponding flag or index is entropy encoded and included in a bitstream in an encoder, and may mean that the corresponding flag or index is entropy decoded from a bitstream in a decoder.

The encoded current image may be used as a reference image for another image to be processed later. Therefore, the encoding apparatus 100 may reconstruct or decode the encoded current image again and store the reconstructed or decoded image as a reference image in the reference picture buffer 190.

A quantized level may be dequantized in the dequantization unit 160, or may be inversely transformed in the inverse transform unit 170. A dequantized and/or inversely transformed coefficient may be added with a prediction block through the adder 117. Herein, the dequantized and/or inversely transformed coefficient may mean a coefficient on which at least one of dequantization and inverse transform is performed, and may mean a reconstructed residual block. The dequantization unit 160 and the inverse transform unit 170 may be performed as an inverse process of the quantization unit 140 and the transform unit 130.

The reconstructed block may pass through the filter unit 180. The filter unit 180 may apply a deblocking filter, a sample adaptive offset (SAO), an adaptive loop filter (ALF), a bilateral filter (BIF), luma mapping with chroma scaling (LMCS), etc. to a reconstructed sample, a reconstructed block or a reconstructed image using all or some filtering techniques. The filter unit 180 may be called an in-loop filter. In this case, the in-loop filter is also used as name excluding LMCS.

The deblocking filter may remove block distortion generated in boundaries between blocks. In order to determine whether or not to apply a deblocking filter, whether or not to apply a deblocking filter to a current block may be determined based on samples included in several rows or columns which are included in the block. When a deblocking filter is applied to a block, a different filter may be applied according to a required deblocking filtering strength.

In order to compensate for encoding error using sample adaptive offset, a proper offset value may be added to a sample value. The sample adaptive offset may correct an offset of a deblocked image from an original image by a sample unit. A method of partitioning a sample included in an image into a predetermined number of regions, determining a region to which an offset is applied, and applying the offset to the determined region, or a method of applying an offset in consideration of edge information on each sample may be used.

A bilateral filter (BIF) may also correct the offset from the original image on a sample-by-sample basis for the image on which deblocking has been performed.

The adaptive loop filter may perform filtering based on a comparison result of the reconstructed image and the original image. Samples included in an image may be partitioned into predetermined groups, a filter to be applied to each group may be determined, and differential filtering may be performed for each group. Information of whether or not to apply the ALF may be signaled by coding units (CUs), and a form and coefficient of the adaptive loop filter to be applied to each block may vary.

In LMCS (Luma Mapping with Chroma Scaling), luma mapping (LM) means remapping luma values through a piece-wise linear model, and chroma scaling (CS) means a technique for scaling the residual value of the chroma component according to the average luma value of the prediction signal. In particular, LMCS may be utilized as an HDR correction technique that reflects the characteristics of HDR (High Dynamic Range) images.

The reconstructed block or the reconstructed image having passed through the filter unit 180 may be stored in the reference picture buffer 190. A reconstructed block that has passed through the filter unit 180 may be a part of a reference image. That is, the reference image is a reconstructed image composed of reconstructed blocks that have passed through the filter unit 180. The stored reference image may be used later in inter prediction or motion compensation.

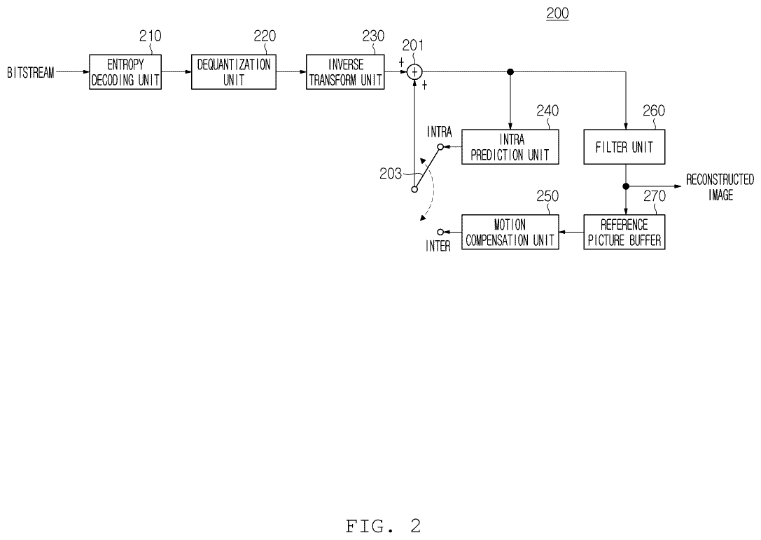

FIG. 2 is a block diagram showing a configuration of a decoding apparatus according to an embodiment of the present invention.

A decoding apparatus 200 may a decoder, a video decoding apparatus, or an image decoding apparatus.

Referring to FIG. 2, the decoding apparatus 200 may include an entropy decoding unit 210, a dequantization unit 220, an inverse transform unit 230, an intra prediction unit 240, a motion compensation unit 250, an adder 201, a switch 203, a filter unit 260, and a reference picture buffer 270.

The decoding apparatus 200 may receive a bitstream output from the encoding apparatus 100. The decoding apparatus 200 may receive a bitstream stored in a computer-readable recording medium, or may receive a bitstream that is streamed through a wired/wireless transmission medium. The decoding apparatus 200 may decode the bitstream in an intra mode or an inter mode. In addition, the decoding apparatus 200 may generate a reconstructed image generated through decoding or a decoded image, and output the reconstructed image or decoded image.

When a prediction mode used for decoding is an intra mode, the switch 20 may be switched to intra. Alternatively, when a prediction mode used for decoding is an inter mode, the switch 203 may be switched to inter.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block and the prediction block. The decoding target block may be called a current block.

The entropy decoding unit 210 may generate symbols by entropy decoding the bitstream according to a probability distribution. The generated symbols may include a symbol of a quantized level form. Herein, an entropy decoding method may be an inverse process of the entropy encoding method described above.

The entropy decoding unit 210 may change a one-dimensional vector-shaped coefficient into a two-dimensional block-shaped coefficient through a transform coefficient scanning method to decode a transform coefficient level (quantized level).

A quantized level may be dequantized in the dequantization unit 220, or inversely transformed in the inverse transform unit 230. The quantized level may be a result of dequantization and/or inverse transform, and may be generated as a reconstructed residual block. Herein, the dequantization unit 220 may apply a quantization matrix to the quantized level. The dequantization unit 220 and the inverse transform unit 230 applied to the decoding apparatus may apply the same technology as the dequantization unit 160 and inverse transform unit 170 applied to the aforementioned encoding apparatus.

When an intra mode is used, the intra prediction unit 240 may generate a prediction block by performing, on the current block, spatial prediction that uses a sample value of a block which has been already decoded around a decoding target block. The intra prediction unit 240 applied to the decoding apparatus may apply the same technology as the intra prediction unit 120 applied to the aforementioned encoding apparatus.

When an inter mode is used, the motion compensation unit 250 may generate a prediction block by performing, on the current block, motion compensation that uses a motion vector and a reference image stored in the reference picture buffer 270. The motion compensation unit 250 may generate a prediction block by applying an interpolation filter to a partial region within a reference image when the value of the motion vector is not an integer value. In order to perform motion compensation, it may be determined whether the motion compensation method of the prediction unit included in the corresponding coding unit is a skip mode, a merge mode, an AMVP mode, or a current picture reference mode based on the coding unit, and motion compensation may be performed according to each mode. The motion compensation unit 250 applied to the decoding apparatus may apply the same technology as the motion compensation unit 122 applied to the encoding apparatus described above.

The adder 201 may generate a reconstructed block by adding the reconstructed residual block and the prediction block. The filter unit 260 may apply at least one of inverse-LMCS, a deblocking filter, a sample adaptive offset, and an adaptive loop filter to the reconstructed block or reconstructed image. The filter unit 260 applied to the decoding apparatus may apply the same filtering technology as that applied to the filter unit 180 applied to the aforementioned encoding apparatus.

The filter unit 260 may output the reconstructed image. The reconstructed block or reconstructed image may be stored in the reference picture buffer 270 and used for inter prediction. A reconstructed block that has passed through the filter unit 260 may be a part of a reference image. That is, a reference image may be a reconstructed image composed of reconstructed blocks that have passed through the filter unit 260. The stored reference image may be used later in inter prediction or motion compensation.

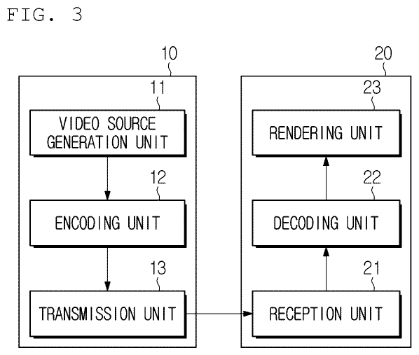

FIG. 3 is a diagram schematically showing a video coding system to which the present invention is applicable.

A video coding system according to an embodiment may include an encoding apparatus 10 and a decoding apparatus 20. The encoding apparatus 10 may transmit encoded video and/or image information or data to the decoding apparatus 20 in the form of a file or streaming through a digital storage medium or a network.

The encoding apparatus 10 according to an embodiment may include a video source generation unit 11, an encoding unit 12, a transmission unit 13. The decoding apparatus 20 according to an embodiment may include a reception unit 21, a decoding unit 22, and a rendering unit 23. The encoding unit 12 may be called a video/image encoding unit, and the decoding unit 22 may be called a video/image decoding unit. The transmission unit 13 may be included in the encoding unit 12. The reception unit 21 may be included in the decoding unit 22. The rendering unit 23 may include a display unit, and the display unit may be configured as a separate device or an external component.

The video source generation unit 11 may obtain the video/image through a process of capturing, synthesizing or generating the video/image. The video source generation unit 11 may include a video/image capture device and/or a video/image generation device. The video/image capture device may include, for example, one or more cameras, a video/image archive including previously captured video/image, etc. The video/image generation device may include, for example, a computer, a tablet and a smartphone, etc., and may (electronically) generate the video/image. For example, a virtual video/image may be generated through a computer, etc., in which case the video/image capture process may be replaced with a process of generating related data.

The encoding unit 12 may encode the input video/image. The encoding unit 12 may perform a series of procedures such as prediction, transform, and quantization for compression and encoding efficiency. The encoding unit 12 may output encoded data (encoded video/image information) in the form of a bitstream. The detailed configuration of the encoding unit 12 may also be configured in the same manner as the encoding apparatus 100 of FIG. 1 described above.

The transmission unit 13 may transmit encoded video/image information or data output in the form of a bitstream to the reception unit 21 of the decoding apparatus 20 through a digital storage medium or a network in the form of a file or streaming. The digital storage medium may include various storage media such as USB, SD, CD, DVD, Blu-ray, HDD, SSD, etc. The transmission unit 13 may include an element for generating a media file through a predetermined file format and may include an element for transmission through a broadcasting/communication network. The reception unit 21 may extract/receive the bitstream from the storage medium or the network and transmit it to the decoding unit 22.

The decoding unit 22 may decode the video/image by performing a series of procedures such as dequantization, inverse transform, and prediction corresponding to the operation of the encoding unit 12. The detailed configuration of the decoding unit 22 may also be configured in the same manner as the above-described decoding apparatus 200 of FIG. 2.

The rendering unit 23 may render the decoded video/image. The rendered video/image may be displayed through the display unit

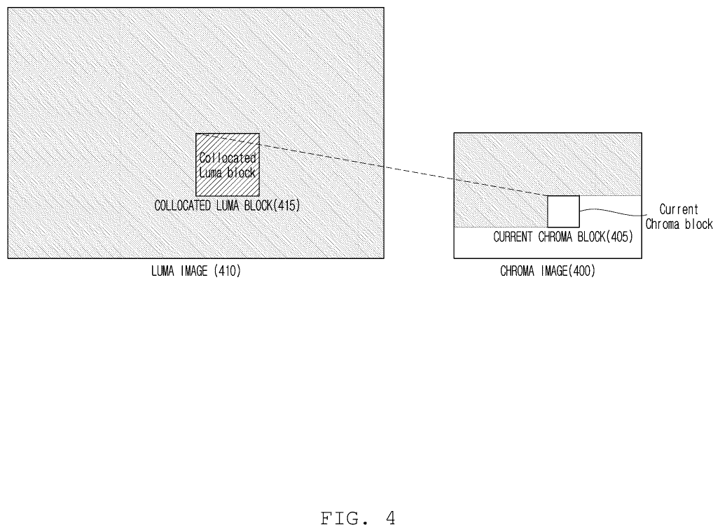

Hereinafter, with reference to FIGS. 4 to 15, a DIMD chroma mode derivation method, a chroma intra prediction mode derivation method, and a method of generating a final chroma difference prediction block based on a weighted sum of a plurality of chroma prediction blocks according to an embodiment of the present invention will be specifically described. Here, DIMD chroma mode means a decoder-side intra mode derivation based chroma intra prediction mode, and may be referred to as ‘derivation based intra prediction mode.’

FIG. 4 is a view for explaining a method of deriving a DIMD chroma mode based on a collocated luma block according to an embodiment of the present invention.

Referring to FIG. 4, the method of deriving the DIMD chroma mode based on the collocated luma block derives the DIMD chroma mode by using a reconstructed pixel of a collocated luma block 415 in a luma image 410 at a collocated position of a current chroma block 405 of a chroma image 400.

Specifically, an encoder/decoder applies a Sobel filter to the reconstructed pixel of the collocated luma block 415 to calculate the gradient of the corresponding pixel, and generates a histogram of gradient (HoG) based on the calculated gradient. Then, the encoder/decoder selects the gradient with the largest value from the histogram of gradient and maps it to an intra prediction mode to derive the intra prediction mode of the chroma block. The derived intra prediction mode of the chroma block may be defined as DIMD chroma mode.

Meanwhile, when generating the histogram of gradient using the reconstructed pixels of the collocated luma block, in order to reduce complexity, the encoder/decoder may perform sampling instead of using all the reconstructed pixels in the collocated luma block to select and use pixels at specific positions. For example, the encoder/decoder may select pixels by sampling x2 (in units of 2 pixels) or x4 (in units of 4 pixels) in the vertical direction, or by sampling x2 (in units of 2 pixels) or x4 (in units of 4 pixels) in the horizontal direction. Alternatively, the encoder/decoder may select pixels by sampling x2 (in units of 2 pixels) or x4 (in units of 4 pixels) in the vertical and horizontal directions. Although sampling of x2 (in units of 2 pixels) or x4 (in units of 4 pixels) is mentioned in the present embodiment, pixels may be selected by sampling of any multiple.

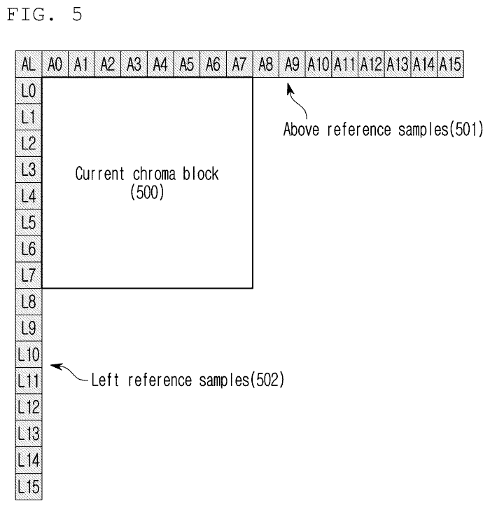

FIGS. 5 and 6 are views for explaining a method of deriving a DIMD chroma mode based on a neighboring reference pixel according to an embodiment of the present invention.

The method of deriving the DIMD chroma mode based on the neighboring reference pixel derives the DIMD chroma mode using the neighboring reference pixel of a current chroma block. Here, the neighboring reference pixel may include an adjacent neighboring reference pixel of the current chroma block and an adjacent reference pixel of a collocated luma block of the current chroma block.

Referring to FIG. 5, the method of deriving the DIMD chroma mode based on the neighboring reference pixel may derive the DIMD chroma mode using the adjacent neighboring reference pixels 501 and 502 of the current chroma block 500.

Specifically, the encoder/decoder applies a Sobel filter to the adjacent neighboring reference pixels 501 and 502 of the current chroma block 500 to calculate the gradients of the corresponding pixels, and generates a histogram of gradient (HoG) based on this. In addition, the encoder/decoder selects the gradient with the largest value from the histogram of gradient and maps it to the intra prediction mode to derive the intra prediction mode of the chroma block. The derived intra prediction mode of the chroma block may be defined as a DIMD chroma mode.

Meanwhile, when the encoder/decoder generates the histogram of gradient using the adjacent neighboring reference pixels of the current chroma block 500, the neighboring reference pixels may be the reconstructed top left reference pixel AL, the above reference pixel 501, and the left reference pixel 502. For example, the above reference pixel 501 used to derive the DIMD chroma mode may be A0 to A7, and the left reference pixel 502 used to derive the DIMD chroma mode may be L0 to L7. As another example, the above reference pixel 501 used to derive the DIMD chroma mode may be A0 to A15, and the left reference pixel 502 used to derive the DIMD chroma mode may be L0 to L15.

Meanwhile, in order to reduce complexity, only selected pixels may be used instead of using all of the above reference pixels 501 and the left reference pixels 502 as neighboring reference pixels used to derive the DIMD chroma mode. For example, the above reference pixels 501 used to derive the DIMD chroma mode may be A0, A2, A4, and A6, and the left reference pixels 502 used to derive the DIMD chroma mode may be L0, L2, L4, and L6.

FIG. 6 is a view explaining an embodiment of using all adjacent neighboring reference pixels of a current chroma block and adjacent reference pixels of a collocated luma block of the current chroma block as neighboring reference pixels in a method of deriving a DIMD chroma mode based on neighboring reference pixels.

Referring to FIG. 6, the method of deriving the DIMD chroma mode based on the neighboring reference pixels may derive a DIMD chroma mode by using at least one of adjacent neighboring reference pixels 601 and 602 of the current chroma block 600 or the adjacent neighboring reference pixels 611 and 612 of the collocated luma block 610 of the current chroma block.

Specifically, the encoder/decoder applies a Sobel filter to at least one of the adjacent neighboring reference pixels 601 and 602 of the current chroma block 600 or the adjacent neighboring reference pixels 611 and 612 of the collocated luma block 610 of the current chroma block to calculate the gradient of the corresponding pixel, and generates a histogram of gradient (HoG) based on the gradient. Then, the encoder/decoder selects the gradient with the largest value from the histogram of gradient and maps it to the intra prediction mode to derive the intra prediction mode of the chroma block. The derived intra prediction mode of the chroma block may be defined as a DIMD chroma mode.

Meanwhile, when the encoder/decoder generates the histogram of gradient using the adjacent neighboring reference pixels of the current chroma block 600, the neighboring reference pixels may be the reconstructed top left reference pixel AL, above reference pixel 601, and left reference pixel 602 adjacent to the current chroma block 600, or the adjacent reconstructed top left reference pixel AL, above reference pixel 611, and left reference pixel 612 of the collocated luma block 610 of the current chroma block.

Here, as described in FIG. 5, the above reference pixels 601 and 611 used to derive the DIMD chroma mode may be A0 to A7, and the left reference pixels 602 and 612 used to derive the DIMD chroma mode may be L0 to L7. As another example, the above reference pixels 601 and 611 used to derive the DIMD chroma mode may be A0 to A15, and the left reference pixels 602 and 612 used to derive the DIMD chroma mode may be L0 to L15.

Meanwhile, in order to reduce complexity, only selected pixels may be used instead of using all of the above reference pixels 601 and 611 and the left reference pixels 602 and 612 as neighboring reference pixels used to derive the DIMD chroma mode. For example, the above reference pixels 601 and 611 used to derive the DIMD chroma mode may be A0, A2, A4, A6, and the left reference pixels 602 and 612 used to derive the DIMD chroma mode may be L0, L2, L4, L6.

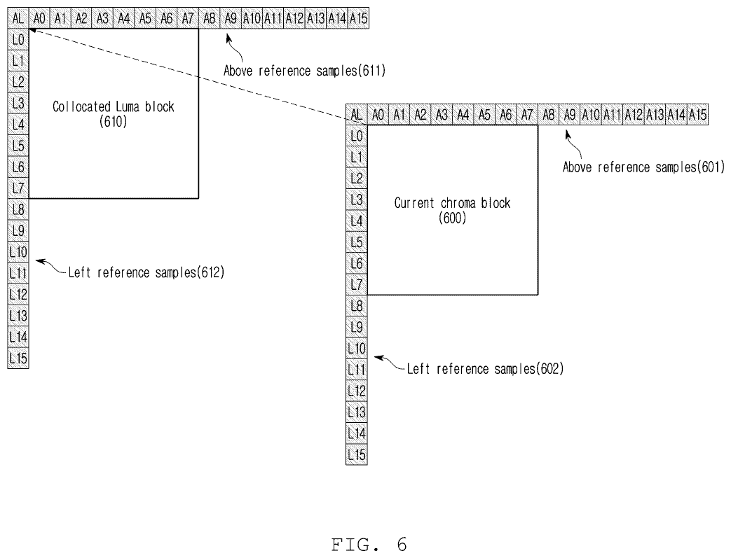

FIG. 7 is a flowchart illustrating a method of deriving a chroma intra prediction mode using a DIMD chroma mode according to an embodiment of the present invention.

Referring to FIG. 7, the encoder/decoder may derive a DIMD chroma mode (S710). Here, the DIMD chroma mode may be derived by the method of deriving the DIMD chroma mode based on the collocated luma block described with reference to FIG. 4 or the method of deriving the DIMD chroma mode based on the neighboring reference pixel described with reference to FIGS. 5 to 6.

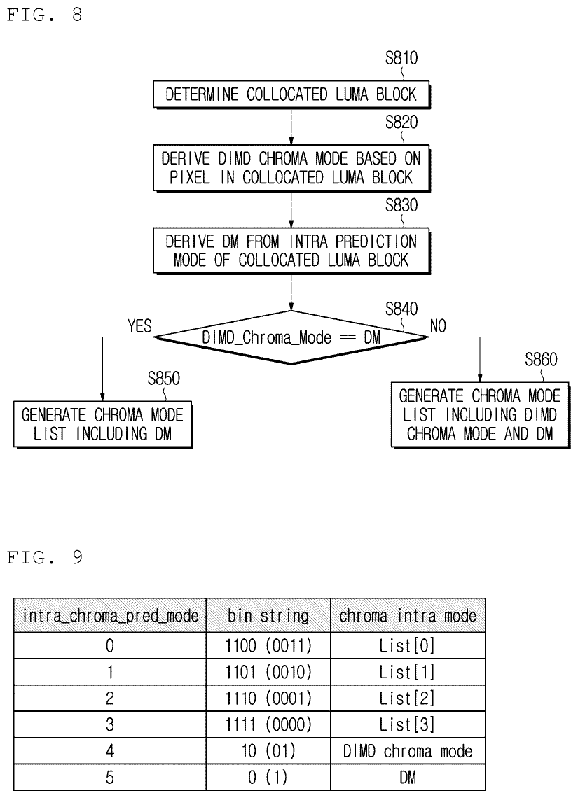

In addition, the encoder/decoder may generate a chroma mode list including the derived DIMD chroma mode (S720). A specific method of generating the chroma mode list will be described later with reference to FIGS. 9 to 12.

In addition, the encoder/decoder may derive a chroma intra prediction mode of a current chroma block based on the chroma mode list (S730). Specifically, the encoder/decoder may derive the chroma intra prediction mode of the current chroma block based on at least one chroma intra prediction mode candidate of the chroma mode list.

According to one embodiment of the present invention, the encoder may transmit information indicating the chroma intra prediction mode of the current chroma block in the chroma mode list, and the decoder may parse the information indicating the chroma intra prediction mode to derive the chroma intra prediction mode of the current chroma block. Here, the information indicating the chroma intra prediction mode may be intra_chroma_pred_mode.

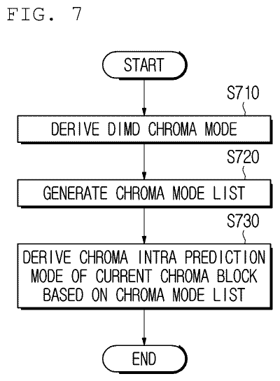

FIG. 8 is a flowchart illustrating a method of deriving a chroma intra prediction mode according to an embodiment of the present invention.

Referring to FIG. 8, the encoder/decoder may determine a collocated luma block (S810) and derive a DIMD chroma mode based on pixels in the determined collocated luma block (S820). Specifically, steps S810 and S820 may be performed by the method of deriving the DIMD chroma mode based on the collocated luma described with reference to FIG. 4.

In addition, the encoder/decoder may derive a DM from the intra prediction mode of the collocated luma block (S830). Here, DM (Direct mode) may be defined as the intra prediction mode of the collocated luma block at the collocated position of the current chroma block.

In addition, the encoder/decoder may determine whether the DIMD chroma mode and the DM are the same (S840).

If the DIMD chroma mode and the DM are the same (S840—Yes), the encoder/decoder may generate a chroma mode list including the DM (S850). In step S850, since the DM and the DIMD chroma mode are the same, any mode may be selected. For example, the chroma mode list may be configured in the order of List [0], List [1], List [2], List [3] and DM, and intra_chroma_pred_mode may indicate each in the order of indexes 0, 1, 2, 3 and 4. Here, List [0] to [3] may be default modes, List [0] may be a Planar mode, List [1] may be 50 (i.e., vertical mode), List [2] may be 18 (i.e., horizontal mode), and List [3] may be a DC mode. Furthermore, overlapping of the default mode in the chroma mode list with the DM is checked, and if DM is identical to the default mode in the chroma mode list, the default mode may be replaced with Mode 66.

Conversely, if the DIMD chroma mode and the DM are not the same (S840—No), the encoder/decoder may generate a chroma mode list including the DIMD chroma mode and the DM (S860). A method of generating the chroma mode list including the DIMD chroma mode and the DM will be described later with reference to FIGS. 9 to 12.

Meanwhile, although in step S850 of FIG. 8, it is described that the chroma mode list including the DM may be generated when the DIMD chroma mode and the DM are the same, according to another embodiment of the present invention, the DM or DIMD chroma mode may be derived as a chroma intra prediction mode of the current chroma block without generating a chroma mode list. Therefore, information indicating the chroma intra prediction mode of the current chroma block in the chroma mode list (for example, intra_chroma_pred_mode) may not be signaled (i.e., transmitted or parsed).

Meanwhile, although, in FIG. 8, the step S820 of deriving the DIMD chroma mode is described as being performed before the step S830 of deriving the DM, according to another embodiment of the present invention, the step S830 of deriving the DM may be performed before the step S820 of deriving the DIMD chroma mode.

FIGS. 9 to 12 are views for explaining a method of generating a chroma mode list according to an embodiment of the present invention.

FIG. 9 is a view for explaining a method of generating a chroma mode list with a predefined order.

Referring to FIG. 9, the chroma mode list may be configured in the order of List [0], List [1], List [2], List [3], DIMD chroma mode and DM, and intra_chroma_pred_mode may indicate each in the order of indexes 0, 1, 2, 3, 4 and 5. In this case, the bin string of intra_chroma_pred_mode for the mode in the chroma mode list may be implemented with 4 bits.

Meanwhile, in the method of generating the chroma mode list with the predefined order, as in FIG. 9, intra_chroma_pred_mode binarization may always be performed in the order of the DM, the DIMD chroma mode, and the default mode (List [0], List [1], List [2] and List [3]).

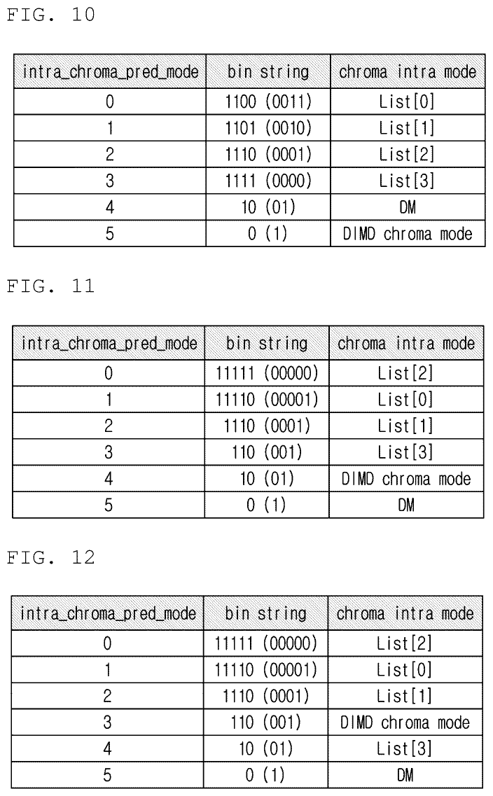

FIG. 10 is a view for explaining a method of generating a chroma mode list based on a histogram of gradient (HoG) generated in a process of deriving a DIMD chroma mode. Specifically, the order of a DIMD chroma mode and a DM in the chroma mode list may be determined based on the histogram of gradient generated in the process of deriving the DIMD chroma mode.

If, in the histogram of gradient generated in the process of deriving the DIMD chroma mode, the gradient value reversely mapped to the DIMD chroma mode is greater than the gradient value reversely mapped to the DM, as shown in FIG. 10, the chroma mode list may be configured in the order of List [0], List [1], List [2], List [3], the DM, and the DIMD chroma mode, and intra_chroma_pred_mode may indicate each in the order of the indexes 0, 1, 2, 3, 4, and 5. That is, if, in the histogram of gradient generated in the process of deriving the DIMD chroma mode, the gradient value reversely mapped to the DIMD chroma mode is greater than the gradient value reversely mapped to the DM, intra_chroma_pred_mode binarization may be performed in the order of the DIMD chroma mode and the DM.

If, in the histogram of gradient generated in the process of deriving the DIMD chroma mode, the gradient value reversely mapped to the DM is greater than the gradient value reversely mapped to the DIMD chroma mode, the chroma mode list may be configured in the order of List [0], List [1], List [2], List [3], the DIMD chroma mode, and the DM, as shown in FIG. 9, and intra_chroma_pred_mode may indicate each in the order of the indexes 0, 1, 2, 3, 4, and 5. That is, if the gradient value reversely mapped to the DM in the histogram of gradient generated in the process of deriving the DIMD chroma mode is greater than the gradient value reversely mapped to the DIMD chroma mode, intra_chroma_pred_mode binarization may be performed in the order of the DM and the DIMD chroma mode.

FIG. 11 is a view for explaining a method of generating a chroma mode list based on a histogram of gradient generated in a DIMD chroma mode derivation process. Specifically, the order of default modes excluding a DIMD chroma mode and a DM in the chroma mode list may be determined based on the histogram of gradient generated in the DIMD chroma mode derivation process.

Using the histogram of gradient generated in the DIMD chroma mode derivation process, the gradient values of default modes excluding the DIMD chroma mode and the DM may be derived and compared, and a chroma mode list may be constructed in order of modes with small gradients. In other words, intra_chroma_pred_mode binarization may be performed in order of modes with large gradients.

If the gradient value of the default mode in the chroma mode list is List [3]>List [1]>List [0]>List [2], the chroma mode list may be constructed as in FIG. 11, and different bits may be assigned to each mode in the chroma mode list to increase encoding efficiency. Meanwhile, although FIG. 11 illustrates an example in which the chroma mode list is constructed in the order of the DM and the DIMD chroma mode, the order of the DM and the DIMD chroma modes may be arbitrarily changed.

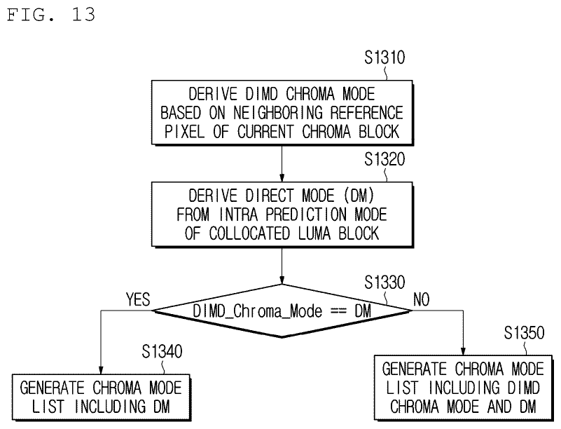

FIG. 12 is a view for explaining a method of generating a chroma mode list based on a histogram of gradient generated in a DIMD chroma mode derivation process. Specifically, the order of all modes in the chroma mode list may be determined based on the histogram of gradient generated in the DIMD chroma mode derivation process.

Using the histogram of gradient generated in the DIMD chroma mode derivation process, the gradient values of all modes in the chroma mode list may be derived and compared to construct the chroma mode list in the order of the modes with small gradients. In other words, intra_chroma_pred_mode binarization may be performed in the order of modes with large gradients.

If the gradient values of the modes in the chroma mode list are DM>List [3]>DIMD chroma mode>List [1]>List [0]>List [2], the chroma mode list may be constructed as shown in FIG. 12, and different bits may be assigned to each mode in the chroma mode list to increase encoding efficiency.

Meanwhile, in the above-described method of generating the chroma mode list, overlapping modes may be checked, and if there is an overlapping mode, it may be replaced with any other specific mode.

For example, if there is a mode overlapping with the DM or DIMD chroma mode among List [0], List [1], List [2], and List [3] of the chroma mode list, the overlapping mode may be replaced with Mode 66.

As another example, the mode overlapping with the DM mode among List [0], List [1], List [2], and List [3] of the chroma mode list may be replaced with Mode n, and the mode overlapping with the DIMD chroma mode may be replaced with Mode m. Here, n and m are different positive integers, and may be 66 and 34, respectively.

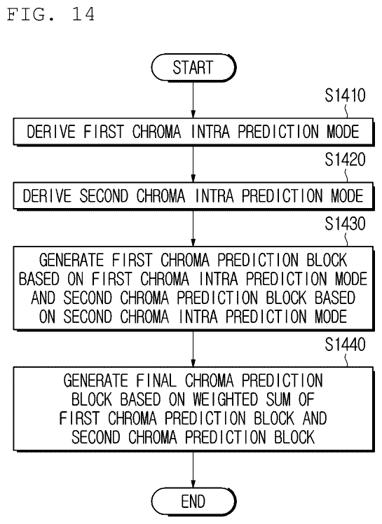

FIG. 13 is a flowchart illustrating a method of deriving a chroma intra prediction mode according to an embodiment of the present invention.

Referring to FIG. 13, the encoder/decoder may derive a DIMD chroma mode based on neighboring reference pixels of a current chroma block (S1310). Here, step S1310 may be performed by the method of deriving the DIMD chroma mode based on neighboring reference pixels described with reference to FIG. 5 or FIG. 6.

In addition, the encoder/decoder may derive a DM (Direct Mode) from the intra prediction mode of a collocated luma block (S1320).

In addition, the encoder/decoder may determine whether the DIMD chroma mode and the DM are the same (S1330).

If the DIMD chroma mode and the DM are the same (S1330—Yes), the encoder/decoder may generate a chroma mode list including the DM or DIMD chroma mode (S1340). Here, since the DM and the DIMD chroma mode are the same, any mode may be selected.

Conversely, if the DIMD chroma mode and the DM are not the same (S1330—No), the encoder/decoder may generate a chroma mode list including the DIMD chroma mode and the DM (S1350). Since the method of generating the chroma mode list including the DIMD chroma mode and the DM was described with reference to FIGS. 9 to 12, a repeated description will be omitted.

Meanwhile, although, in step S1340 of FIG. 13, it is described that the chroma mode list including the DM may be generated when the DIMD chroma mode and the DM are the same, according to another embodiment of the present invention, the DM or DIMD chroma mode may be derived as a chroma intra prediction mode of the current chroma block without generating a chroma mode list. Therefore, information indicating the chroma intra prediction mode of the current chroma block in the chroma mode list (for example, intra_chroma_pred_mode) may not be signaled (i.e., transmitted or parsed).

Meanwhile, although, in step S1340 of FIG. 13, it is described that the step S1310 of deriving the DIMD chroma mode is performed before the step S1320 of deriving the DM, according to another embodiment of the present invention, the step S1320 of deriving the DM may be performed before the step S1310 of deriving the DIMD chroma mode.

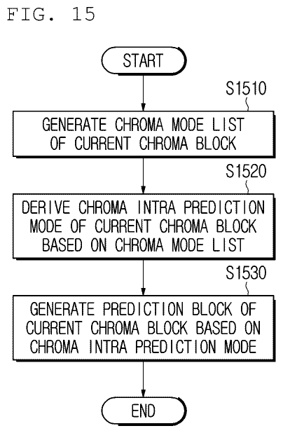

FIG. 14 is a flowchart illustrating a method of generating a final chroma prediction block based on a weighted sum of a plurality of chroma prediction blocks according to an embodiment of the present invention.

Referring to FIG. 14, the encoder/decoder may derive a first chroma intra prediction mode (S1410) and derive a second chroma intra prediction mode (S1420).

Specifically, the first chroma intra prediction mode and the second chroma intra prediction mode may be determined from among a default mode, a direct mode (DM), a DIMD chroma mode, a cross component linear model (CCLM) mode, and a multi-model linear model (MMLM) mode.

Here, the default mode may be a Planar mode, Mode 50 (i.e., vertical mode), Mode 18 (i.e., horizontal mode), a DC mode, as in List [0], List [1], List [2], and List [3] of FIGS. 9 to 12. The CCLM mode is a cross-component linear model mode, which is a mode that predicts a chroma block using a linear model that calculates a correlation between reconstructed luma component samples at collocated positions of a chroma component sample. The MMLM mode is a multi-model linear model mode, which is a mode that predicts a chroma block using multiple linear models.

Then, the encoder/decoder may generate a first chroma prediction block based on the first chroma intra prediction mode and a second chroma prediction block based on the second chroma intra prediction mode, respectively (S1430), and generate a final chroma prediction block based on a weighted sum of the first chroma prediction block and the second chroma prediction block (S1440).

$$Chroma\_pred = w 0 \times pred 0 + w 1 \times pred 1 \qquad [ Equation 1 ]$$

According to Equation 1, a first weight w0 and a second weight w1 may be respectively applied to the first chroma prediction block pred0 and the second chroma prediction block pred1 to generate a final chroma prediction block Chroma_pred. Here, the sum of the first weight w0 and the second weight w1 is 1.

In the method of generating the final chroma prediction block based on the weighted sum, the first chroma intra prediction mode and the second chroma intra prediction mode may be determined from a first chroma intra prediction mode candidate set and a second chroma intra prediction mode candidate set, respectively.

Table 1 shows various embodiments of the first chroma intra prediction mode candidate set and the second chroma intra prediction mode candidate set.

TABLE 1

| | First chroma intra | Second chroma intra |
|---|---|---|
| | prediction candidate set | prediction candidate set |
| First | default mode, DM, DIMD | default mode, DM, DIMD |
| combination | chroma mode, CCLM | chroma mode, CCLM |
| | mode, MMLM mode | mode, MMLM mode |
| Second | CCLM | default mode, DM, DIMD |
| combination | | chroma mode, MMLM mode |
| Third | CCLM | default mode, DM, DIMD |
| combination | | chroma mode |
| Fourth | MMLM | default mode, DM, DIMD |
| combination | | chroma mode, CCLM mode |
| Fifth | MMLM | default mode, DM, DIMD |
| combination | | chroma mode |
| Sixth | CCLM, MMLM | default mode, DM, DIMD |
| combination | | chroma mode |

According to the first combination of Table 1, the first chroma intra prediction mode candidate set and the second chroma intra prediction mode candidate set may equally include the default mode, the DM, the DIMD chroma mode, the CCLM mode, and the MMLM mode. In the case of the first combination of Table 1, it may be implemented with a syntax transmission/parsing structure as in Table 2.

TABLE 2
Syntax transmission/parsing structure

chroma_weight_pred_flag transmission/parsing
if (chroma_weight_pred_flag true)
intra_chroma_pred_mode_pred0 transmission/parsing
intra_chroma_pred_mode_pred1 transmission/parsing
Chroma_pred = w0 x pred0 + w1 x pred1
else
intra_chroma_pred_mode transmission/parsing
Chroma_pred = pred

In Table 2, chroma_weight_pred_flag is a syntax that determines whether to use a method of generating a final chroma prediction block based on a weighted sum. Therefore, if the chroma_weight_pred_flag syntax is true, a final chroma prediction block may be generated based on a weighted sum of prediction blocks generated based on a plurality of chroma intra prediction modes. Specifically, intra_chroma_pred_mode_pred0 and intra_chroma_pred_mode_pred1 syntaxes may be transmitted/parsed to generate a first chroma prediction block pred0 and a second chroma prediction block pred1, and a final chroma prediction block Chroma_pred may be derived. Here, intra_chroma_pred_mode_pred0 and intra_chroma_pred_mode_pred1 may be a syntax indicating a first chroma intra prediction mode and a syntax indicating a second chroma intra prediction mode. In Table 2, if the chroma_weight_pred_flag syntax is false, the final chroma prediction block Chroma_pred may be generated from one chroma intra prediction mode. Here, intra_chroma_pred_mode is a syntax indicating a chroma intra prediction mode, and pred means a chroma prediction block generated based on intra_chroma_pred_mode.

Meanwhile, the second to sixth combinations of Table 1 may also be implemented with a syntax transmission/parsing structure shown in Table 2. In this case, intra_chroma_pred_mode_pred0 and intra_chroma_pred_mode_pred1 may be a syntax indicating a first chroma intra prediction mode in a first chroma intra prediction mode candidate set and a syntax indicating a second chroma intra prediction mode in a second chroma intra prediction mode candidate set.

According to the second combination of Table 1, the first chroma intra prediction mode candidate set may include only CCLM, and the second chroma intra prediction mode candidate set may include default mode, DM, DIMD chroma mode, and MMLM mode. According to the third combination of Table 1, the first chroma intra prediction mode candidate set may include only CCLM, and the second chroma intra prediction mode candidate set may include default mode, DM, and DIMD chroma mode. For the second and third combinations of Table 1, it may be implemented with a syntax transmission/parsing structure as in Table 3.

TABLE 3
Syntax transmission/parsing structure

```
intra_chroma_pred_mode_pred0 transmission/parsing
if (pred0 == CCLM)
  chroma_weight_pred_flag transmission/parsing
if (chroma_weight_pred_flag true)
intra_chroma_pred_mode_pred1 transmission/parsing
Chroma_pred = w0 x pred_CCLM + w1 x pred1
    else
      Chroma_pred = pred_CCLM
else
  Chroma_pred = pred0
```

In Table 3, intra_chroma_pred_mode_pred0 and intra_chroma_pred_mode_pred1 are a syntax indicating a first chroma intra prediction mode and a syntax indicating a second chroma intra prediction mode, and chroma_weight_pred_flag is a syntax that determines whether to use a method of generating a final chroma prediction block based on a weighted sum.

According to Table 3, the intra_chroma_pred_mode_pred0 syntax may be transmitted/parsed to generate the first chroma prediction block pred0. If the first chroma prediction block pred0 is not a CCLM-predicted block, the final chroma prediction block Chroma_pred may be set to the first chroma prediction block pred0. Conversely, if the first chroma prediction block pred0 is a CCLM-predicted block, the chroma_weight_pred_flag syntax may be transmitted/parsed. If the chroma_weight_pred_flag syntax is false, the final chroma prediction block Chroma_pred may be set to a CCLM-predicted block pred_CCLM (i.e., the first chroma prediction block pred0). If the chroma_weight_pred_flag syntax is true, the intra_chroma_pred_mode_pred1 syntax may be transmitted/parsed, and the final chroma prediction block Chroma_pred may be generated by a weighted sum of the CCLM-predicted block pred_CCLM (i.e., the first chroma prediction block pred0) and the second chroma prediction block pred1 based on intra_chroma_pred_mode_pred1.

According to the fourth combination of Table 1, the first chroma intra prediction mode candidate set may include only MMLM, and the second chroma intra prediction mode candidate set may include default mode, DM, DIMD chroma mode, and CCLM mode. According to the fifth combination of Table 1, the first chroma intra prediction mode candidate set may include only MMLM, and the second chrominance intra prediction mode candidate set may include default mode, DM, and DIMD chroma mode. For the fourth and fifth combinations of Table 1, it may be implemented with a syntax transmission/parsing structure as in Table 4.

TABLE 4
Syntax transmission/parsing structure

```
intra_chroma_pred_mode_pred0 transmission/parsing
if (pred0 == MMLM)
  chroma_weight_pred_flag transmission/parsing
if (chroma_weight_pred_flag true)
intra_chroma_pred_mode_pred1 transmission/parsing
Chroma_pred = w0 x pred_MMLM + w1 x pred1
    else
      Chroma_pred = pred_MMLM
else
  Chroma_pred = pred0
```

In Table 4, intra_chroma_pred_mode_pred0 and intra_chroma_pred_mode_pred1 are a syntax indicating a first chroma intra prediction mode and a syntax indicating a second chroma intra prediction mode, and chroma_weight_pred_flag is a syntax that determine whether to use a method of generating a final chroma prediction block based on a weighted sum.

According to Table 4, the intra_chroma_pred_mode_pred0 syntax may be transmitted/parsed to generate a first chroma prediction block pred0. If the first chroma prediction block pred0 is not a MMLM-predicted block, the final chroma prediction block Chroma_pred may be set to the first chroma prediction block pred0. Conversely, if the first chroma prediction block pred0 is a MMLM-predicted block, the chroma_weight_pred_flag syntax may be transmitted/parsed. If the chroma_weight_pred_flag syntax is false, the final chroma prediction block Chroma_pred may be set to a MMLM-predicted block pred_MMLM (i.e., the first chroma prediction block pred0). If the chroma_weight_pred_flag syntax is true, the intra_chroma_pred_mode_pred1 syntax may be transmitted/parsed, and the final chroma prediction block Chroma_pred may be generated by a weighted sum of the MMLM-predicted block pred_MMLM (i.e., the first chroma prediction block pred0) and the second chroma prediction block pred1 based on intra_chroma_pred_mode_pred1.

According to the sixth combination of Table 1, the first chroma intra prediction mode candidate set may include CCLM and MMLM, and the second chrominance intra prediction mode candidate set may include default mode, DM, and DIMD chroma mode. For the sixth combination of Table 1, it may be implemented with a syntax transmission/parsing structure as in Table 5.

TABLE 5
Syntax transmission/parsing structure

```
intra_chroma_pred_mode_pred0 transmission/parsing
if (pred0 == CCLM or pred0 == MMLM)
  chroma_weight_pred_flag transmission/parsing
if (chroma_weight_pred_flag true)
intra_chroma_pred_mode_pred1 transmission/parsing
Chroma_pred = w0 x pred0 + w1 x pred1
    else
      Chroma_pred = pred0
else
  Chroma_pred = pred0
```

In Table 5, intra_chroma_pred_mode_pred0 and intra_chroma_pred_mode_pred1 are a syntax indicating a first chroma intra prediction mode and a syntax indicating a second chroma intra prediction mode, and chroma_weight_pred_flag is a syntax that determine whether to use a method of generating a final chroma prediction block based on a weighted sum.

According to Table 5, the intra_chroma_pred_mode_pred0 syntax may be transmitted/parsed to generate the first chroma prediction block pred0. If the first chroma prediction block pred0 is not a CCLM- or MMLM-predicted block, the final chroma prediction block Chroma_pred may be set to the first chroma prediction block pred0. Conversely, if the first chroma prediction block pred0 is a CCLM- or MMLM-predicted block, the chroma_weight_pred_flag syntax may be transmitted/parsed. If the chroma_weight_pred_flag syntax is false, the final chroma prediction block Chroma_pred may be set to the first chroma prediction block pred0. If the chroma_weight_pred_flag syntax is true, the intra_chroma_pred_mode_pred1 syntax may be transmitted/parsed, and the final chroma prediction block Chroma_pred may be generated by a weighted sum of the first chroma prediction block pred0 and the second chroma prediction block pred1 based on intra_chroma_pred_mode_pred1.

Meanwhile, although, in FIG. 14 and Tables 1 to 5, a method of generating a final chroma prediction block by a weighted sum of two chroma prediction blocks is described, a final chroma prediction block may be generated by a weighted sum of N chroma prediction blocks generated from any N chroma intra prediction modes. At this time, the sum of the weights used in the weighted sum may be 1 (w0+w1+ . . . +wN=1).

Meanwhile, in the above-described method of generating the final chroma prediction block based on the weighted sum, the weights may be pre-determined (for example, w0=0.5, w1=0.5) or adaptively determined by weight information. For example, the weight information may be derived by an implicit method derived from a neighboring block or an explicit method signaled through a bitstream.

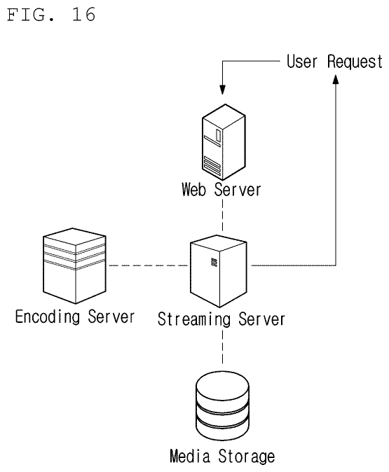

FIG. 15 is a flowchart illustrating an image decoding method according to an embodiment of the present invention. The image decoding method of FIG. 15 may be performed by the image decoding apparatus.

Referring to FIG. 15, the image decoding apparatus may generate a chroma mode list of a current chroma block (S1510). Here, the chroma mode list may include at least one of a default mode, a derivation based chroma mode, and a direct mode.

The derivation based chroma mode is the aforementioned DIMD chroma mode, which may be derived using a reconstructed pixel of a collocated luma block at a collocated position of the current chroma block, or may be derived using reconstructed neighboring reference pixels of the current chroma block.

When the reconstructed pixels of the collocated block are used to derive the derivation based chroma mode, the reconstructed pixels of the collocated block may be pixels selected by sampling among pixels in the collocated luma block.

When the reconstructed neighboring reference pixels are used to derive the derivation based chroma mode, the neighboring reference pixels may include at least one of the neighboring reference pixels adjacent to the current chroma block or the neighboring reference pixels adjacent to the collocated luma block of the current chroma block. Alternatively, the neighboring reference pixels may be pixels directly adjacent to the current chroma block.

The derivation of the derivation based chroma mode was specifically described in FIG. 4 and FIG. 5-6.

Meanwhile, according to one embodiment of the present invention, the chroma mode list may be constructed in the order of the direct mode, the derived chroma mode, and the default mode.

Alternatively, the chroma mode list may be constructed in the order determined based on a histogram of gradient for deriving the derivation chroma mode.

Meanwhile, according to an embodiment of the present invention, if the direct mode and the derivation chroma mode are the same intra prediction mode, the chroma intra prediction mode of the current chroma block may be set to the same intra prediction mode.

Meanwhile, according to one embodiment of the present invention, if there is a default mode having the same intra prediction mode as the direct mode or the derivation chroma mode, the default mode may be replaced with a predefined chroma intra prediction mode. Here, the predefined chroma intra prediction mode may be the last directional intra prediction mode (for example, Mode 66).

In addition, the image decoding apparatus may derive the chroma intra prediction mode of the current chrominance block based on the chroma mode list generated in step S1510 (S1520). Specifically, the image decoding apparatus may derive the chroma intra prediction mode of the current chrominance block based on at least one chroma intra prediction mode candidate of the chroma mode list.

According to one embodiment of the present invention, the encoder may transmit information indicating the chroma intra prediction mode of the current chroma block in the chroma mode list, and the decoder may parse the information indicating the chroma intra prediction mode to derive the chroma intra prediction mode of the current chroma block. Here, the information indicating the chroma intra prediction mode may be intra_chroma_pred_mode.

In addition, the image decoding apparatus may generate a prediction block of the current chroma block based on the chroma intra prediction mode derived in step S1520 (S1530).

Meanwhile, the steps described in FIG. 15 may be performed in the same manner in an image encoding method. In addition, a bitstream may be generated by an image encoding method including the steps described in FIG. 15. The bitstream may be stored in a non-transitory computer-readable recording medium, and may also be transmitted (or streamed).

FIG. 16 exemplarily illustrates a content streaming system to which an embodiment according to the present invention is applicable.

As illustrated in FIG. 16, a content streaming system to which an embodiment of the present invention is applied may largely include an encoding server, a streaming server, a web server, a media storage, a user device, and a multimedia input device.

The encoding server compresses content received from multimedia input devices such as smartphones, cameras, CCTVs, etc. into digital data to generate a bitstream and transmits it to the streaming server. As another example, if multimedia input devices such as smartphones, cameras, CCTVs, etc. directly generate a bitstream, the encoding server may be omitted.

The bitstream may be generated by an image encoding method and/or an image encoding apparatus to which an embodiment of the present invention is applied, and the streaming server may temporarily store the bitstream in the process of transmitting or receiving the bitstream.

The streaming server transmits multimedia data to a user device based on a user request via a web server, and the web server may act as an intermediary that informs the user of any available services. When a user requests a desired service from the web server, the web server transmits it to the streaming server, and the streaming server may transmit multimedia data to the user. At this time, the content streaming system may include a separate control server, and in this case, the control server may control commands/responses between devices within the content streaming system.

The streaming server may receive content from a media storage and/or an encoding server. For example, when receiving content from the encoding server, the content may be received in real time. In this case, in order to provide a smooth streaming service, the streaming server may store the bitstream for a certain period of time.

Examples of the user devices may include mobile phones, smartphones, laptop computers, digital broadcasting terminals, personal digital assistants (PDAs), portable multimedia players (PMPs), navigation devices, slate PCs, tablet PCs, ultrabooks, wearable devices (e.g., smartwatches, smart glasses, HMDs), digital TVs, desktop computers, digital signage, etc.

Each server in the above content streaming system may be operated as a distributed server, in which case data received from each server may be distributed and processed.

The above embodiments may be performed in the same or corresponding manner in the encoding apparatus and the decoding apparatus. In addition, an image may be encoded/decoded using at least one or a combination of at least one of the above embodiments.

The order in which the above embodiments are applied may be different in the encoding apparatus and the decoding apparatus. Alternatively, the order in which the above embodiments are applied may be the same in the encoding apparatus and the decoding apparatus.

The above embodiments may be performed for each of the luma and chroma signals. Alternatively, the above embodiments for the luma and chroma signals may be performed identically.

In the above-described embodiments, the methods are described based on the flowcharts with a series of steps or units, but the present invention is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present invention.

The embodiments may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present invention, or well-known to a person of ordinary skilled in computer software technology field.

A bitstream generated by the encoding method according to the above embodiment may be stored in a non-transitory computer-readable recording medium. In addition, a bitstream stored in the non-transitory computer-readable recording medium may be decoded by the decoding method according to the above embodiment.

Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high level language code that may be implemented by a computer using an interpreter. The hardware devices may be configured to be operated by one or more software modules or vice versa to conduct the processes according to the present invention.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

The present invention may be used in an apparatus for encoding/decoding an image and a recording medium for storing a bitstream.

1. An image decoding method comprising:
generating a chroma mode list of a current chroma block;
deriving a chroma intra prediction mode of the current chroma block based on the chroma mode list; and
generating a prediction block of the current chroma block based on the chroma intra prediction mode,
wherein the chroma mode list comprises at least one of a default mode, a derivation based chroma mode or a direct mode.

2. The image decoding method of claim 1, wherein the derivation based chroma mode is derived using a reconstructed pixel of a collocated luma block at a collocated position of the current chroma block.

3. The image decoding method of claim 2, wherein the reconstructed pixel of the collocated luma block is a pixel selected by sampling.

4. The image decoding method of claim 1, wherein the derivation based chroma mode is derived using a reconstructed neighboring reference pixel of the current chroma block.

5. The image decoding method of claim 4, wherein the neighboring reference pixel is a pixel directly adjacent to the current chroma block.

6. The image decoding method of claim 4, wherein the neighboring reference pixel comprises at least one of a neighboring reference pixel adjacent to the current chroma block or a neighboring reference block adjacent to the collocated block of the current chroma block.

7. The image decoding method of claim 1, wherein the chroma mode list is configured in the order of the direct mode, the derivation based chroma mode and the default mode.

8. The image decoding method of claim 1, wherein the chroma mode list is configured in an order determined based on a histogram of gradient for deriving the derivation based chroma mode.

9. The image decoding method of claim 1, wherein when the direct mode and the derivation based chroma mode are the same intra prediction mode, the chroma intra prediction mode of the current chroma block is set to the same intra prediction mode.

10. The image decoding method of claim 1, wherein when there is a default mode having the same intra prediction mode as the direct mode or the derivation based chroma mode, the default mode is replaced with a predefined chroma intra prediction mode.

11. An image encoding method comprising:
generating a chroma mode list of a current chroma block;
deriving a chroma intra prediction mode of the current chroma block based on the chroma mode list; and
generating a prediction block of the current chroma block based on the chroma intra prediction mode,
wherein the chroma mode list comprises at least one of a default mode, a derivation based chroma mode or a direct mode.

12. (canceled)

13. A method of transmitting a bitstream generated by an image encoding method, the method comprising:
transmitting the bitstream,
wherein the image encoding method comprises:
generating a chroma mode list of a current chroma block;
deriving a chroma intra prediction mode of the current chroma block based on the chroma mode list; and
generating a prediction block of the current chroma block based on the chroma intra prediction mode,
wherein the chroma mode list comprises at least one of a default mode, a derivation based chroma mode or a direct mode.
